(19) United States
(12) Patent Application Publication
(10) Pub. No.: US 2002/0018034 A1
(43) Pub. Date: Feb. 14, 2002

(54) Display color temperature corrected lighting apparatus and flat plane display apparatus

(76) Inventors: Shigeru Ohki, Chiba-shi (JP); Satoshi Arai, Chiba-shi (JP)

Correspondence Address: ADAMS & WILKS, ATTORNEYS AND COUNSELORS AT LAW, 31st Floor, 50 Broadway, New York, NY, 10004, US

(21) Appl. No.: 09/915,596

(22) Filed: Jul. 26, 2001

(30) Foreign Application Priority Data
Jul. 31, 2000 (JP) 2000-231973

(51) Int. Cl. G09G 3/30

(52) U.S. Cl. 345/77

(57) ABSTRACT

Even when a display color temperature of a flat plane display apparatus is corrected, a total color representation number is not reduced.

In a flat plane display module, both a light conducting plate and light emitting elements are fixed on a printed board. Furthermore, while a flat plane display apparatus is fixed on the light conducting plate, the respective light emitting elements, and the flat plane display apparatus are electrically connected to the printed board. The color temperature of the light emitting elements is changed by a circuit provided on the printed board so as to control the display color of the flat plane display apparatus. As a result, the display color of the flat plane display apparatus can be changed by the color temperature of the lighting, and the display color temperature of the flat plane display apparatus is corrected.

### BACKGROUND OF THE INVENTION

1. Field of the Invention

The present invention is related to a method for correcting a color temperature of a display color of a flat plane display apparatus by a lighting apparatus equipped with a color temperature adjusting function of a flat plane display module.

2. Description of the Prior Art

Conventionally, while a display color temperature of a flat plane display apparatus is corrected, such a color temperature correction is carried out by controlling image signals of the three RGB colors provided with the flat plane display apparatus. In the case that a light source for lightening a display screen is mounted, as shown in FIG. 2, a light 10 such as an FL is employed. In this case, light emitting elements made of three RGB colors are not provided in the light 10, but a light source of a white light color, or having a color temperature approximated to the white light color is employed as the light 10.

Conventionally, the liquid crystal color temperature correction is carried out by correcting the respective image signals of the three RGB colors. As a consequence, in such a case that a voltage difference applied when all of the liquid crystal is turned ON and also is turned OFF is selected to be 100% for each of RGB before the color temperature correction assuming now that voltage differences after the color temperature correction are selected to be, for example, R: 80%, G: 90%, and B: 100%, a total color representation number of “R” is reduced by 20% and a total color representation number of “G” is reduced by 10%. In other words, when each of these three colors may be expressed by resolution of 8 bits, there is such a problem that 16,770,000 colors can be displayed before the color temperature correction, whereas these original colors are reduced to 12,010,000 colors after the color temperature correction.

### SUMMARY OF THE INVENTION

To solve the above-explained problem, the present invention is featured such that a color temperature correction of a flat plane display apparatus is carried out not by adjusting a liquid crystal drive voltage so as to control a light amount of lightening light which passes through each of RGB filters. While the lightening light is constituted by light sources made of a plurality of colors, for example, three RGB colors, light emission strengths of the respective RGB lightening light are adjusted so as to control color temperatures, so that the flat plane display apparatus can correct the color temperatures without reducing total color representation numbers.

### BRIEF DESICRIPTION OF THE DRAWINGS

A preferred form of the present invention is illustrated in the accompanying drawings in which:

FIG. 1 is a perspective view for indicating an embodiment of a flat plane display module in which lighting of a flat plane display apparatus of the present invention is constituted by light emitting elements made of three RGB colors and a light conducting plate;

FIG. 2 is a perspective view for indicating the flat plane display module representative of the lighting example of the conventional flat plane display apparatus;

FIG. 3 is a characteristic diagram between a drive voltage of liquid crystal and brightness as an example of the flat plane display apparatus;

FIG. 4 is a perspective view for indicating an embodiment of a flat plane display module in which lighting of a flat plane display apparatus of the present invention is constituted by light emitting elements made of three RGB colors;

FIG. 5 is a perspective view for representing an embodiment in which lighting of a flat plane display apparatus of the present invention is constituted by arranging light emitting elements made of three RGB colors at each of vertexes of a triangle on a side surface of a light conducting plate;

FIG. 6 is a perspective view for representing an embodiment in which lighting of a flat plane display apparatus of the present invention is constituted by arranging light emitting elements made of three RGB colors at each of vertexes of a triangle in multiple stages;

FIG. 7 is a perspective view for representing an embodiment in which lighting of a flat plane display apparatus of the present invention is constituted by repeatedly arranging light emitting elements made of three RGB colors in a serial manner on a side surface of a light conducting plate;

FIG. 8 is a perspective view for showing an embodiment of such a construction that lighting of a flat plane display apparatus of the present invention is constituted such that a reflection plate is provided on a side surface of a light conducting plate so as to acquire light from a light source;

FIG. 9 is a sectional view of the embodiment construction shown in FIG. 8;

FIG. 10 is a sectional view for showing an embodiment in which plural sets of the reflection plates of FIG. 9 are employed, and a position of a light source is changed; and

FIG. 11 is a sectional view for representing an embodiment of such a construction that lighting of a flat plane display apparatus of the present invention is constituted such that while an optical fiber is positioned close to a side surface of a light conducting plate, light is collected by the optical fiber so as to conduct the light into the light conducting plate.

### DETAILED DESCRIPTION OF THE PREFERRED EMBODIMENTS

The present invention is featured such that while either a front-face lighting apparatus or a rear-face lighting apparatus (referred to as “lighting apparatus” hereinafter) is arranged on a flat plane display apparatus, a color temperature of this lighting apparatus is changed in order to correct a display color temperature of the flat plane display apparatus.

The above-explained lightening apparatus is constituted by light sources made of three RGB colors. Since light emission strengths of the respective three RGB colors are adjusted, the display color temperature of the flat plane display apparatus can be corrected.

Then, when the lighting apparatus is constituted by light emitting elements of three RGB colors, the color temperature control can be carried out. In addition, the lighting apparatus can have superior features as a light source, for instance, high brightness (luminance), compactness, low power consumption, long lifetime, anti-shock characteristic, and so on.

Also, while the flat plane display module is arranged by white liquid crystal and the lighting apparatus is constituted by light emitting elements of three RGB colors, since the color temperature control is carried out, it is possible to obtain a desirable color temperature liquid crystal screen.

Also, while a light conducting plate is provided with the lighting apparatus, since light emitting elements made of three RGB colors are arranged on a side surface of the light conducting plate (namely, outer peripheral surface of light conducting plate which is defined at a right angle with respect to light emission surface of the light conducting plate), the lighting apparatus can be made slim.

Furthermore, in the case that light emitting elements made of three RGB colors used as the lighting apparatus are arranged on the side surface of the light conducting plate, one set of the light emitting elements made of the three RGB colors is constituted by closely combining these light emitting elements in a serial manner, and plural sets of these light emitting elements are repeatedly arranged in a serial manner. Also, one set of the light emitting elements made of the three RGB colors is constituted by closely combining these light emitting elements at each of vertexes of a triangle, and one set of light emitting elements is arranged in such a manner that this one set is alternately and repeatedly arranged in the triangular manner and the inverse-triangular manner. As a result, the three RGB colors are mixed with each other in a proper manner, so that such white light having a small number of color patterns and a small number of brightness patterns can be obtained from the light emitting surface of the light conducting plate.

Also, since a reflection plate is arranged on the side surface of the light conducting plate in order to conduct light emitted from the light source made of the three RGB colors to the light conducting plate, the flat plate display apparatus may be adapted to various shapes of lighting apparatus, or various types of lighting apparatus.

As previously described, while the light sources made of the three RGB colors are employed in the lighting apparatus, when the color temperatures are properly adjusted by combining the three colored light emissions with each other, the display screen of the flat plate display apparatus can be set to the desirable temperature without reducing a total number of representable colors.

[Embodiment]

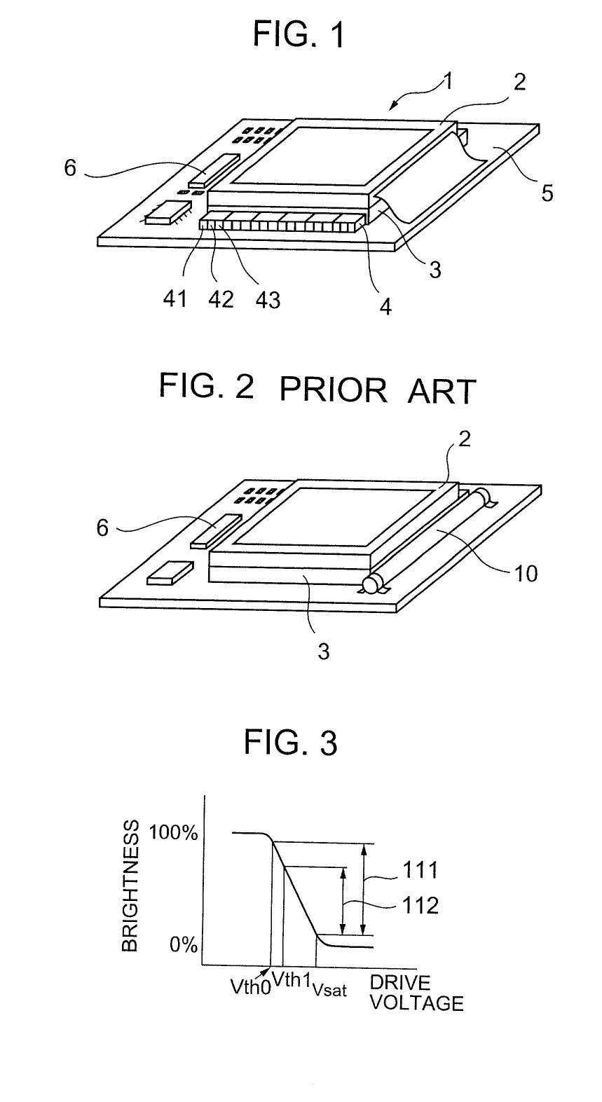

Referring now to drawings, an embodiment of the present invention will be described. In FIG. 1, in a flat plane display module 1, both a light conducting plate 3 and light emitting elements 4 are fixed on a printed board 5. Furthermore, while liquid crystal 2 is fixed on the light conducting plate, a flat plate display apparatus 2, a red light emitting element 41, a green light emitting element 42, and a blue light emitting element 43 are electrically connected to the printed board 5 respectively. Both a color temperature of light emitting elements 4 and a liquid crystal display are controlled by a circuit 6 provided on the printed board 5.

FIG. 3 is a characteristic diagram for representing a relationship between brightness (luminance) and a drive voltage of the liquid crystal.

In such a case that the brightness of each of the display RGB elements is made different from each other due to fluctuations in the components which constitute the flat plane display module 1 and therefore the color temperatures are fluctuated, when the brightness of the respective display RGB elements is changed from Vth0 to Vth1 so as to correct the color temperatures in a similar manner to the prior art, the variable range of the brightness is made narrow, and also a total number of display colors made by combining the three RGB colors of the display elements is reduced.

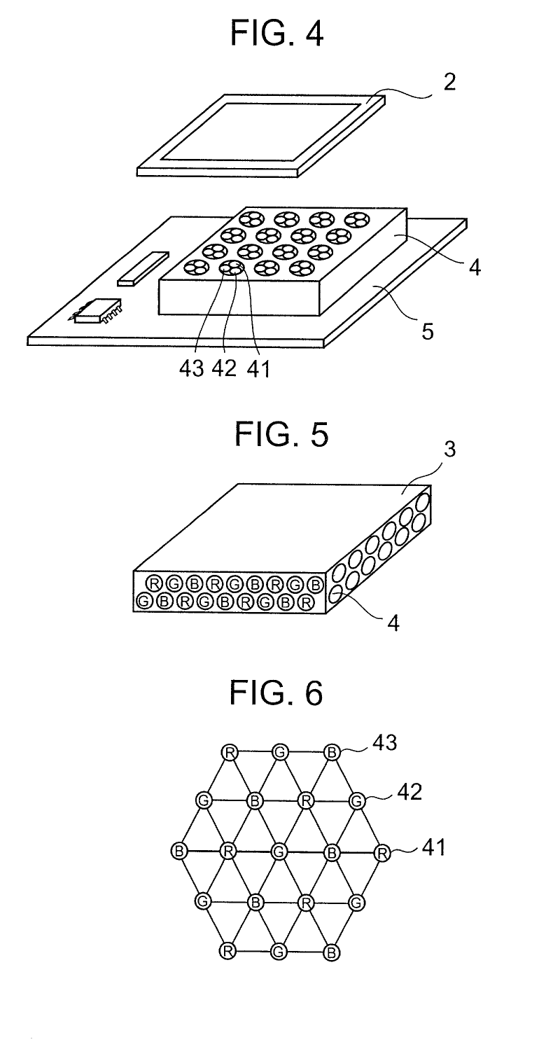

In an embodiment shown in FIG. 4, while the light conducting plate 3 as explained in FIG. 1 is not employed, a light emitting element group 4 made of three RGB colors is directly provided on a rear surface (lower surface) of the liquid crystal 2, and is combined with a flat plane display apparatus 2. Similar to FIG. 1, while the light emitting element group 4 is mounted on the printed board 5, the color temperature is adjusted as well as the display control of the flat plane display apparatus is carried out.

An embodiment shown in FIG. 5 corresponds to such an example that three-color light emitting elements 4 are fixed/arranged on a side surface of a light conducting plate 3 in a triangular shape. With employment of such a structure, since the respective colors of the three RGB light emitting elements are distributed without any deviation, the color patterns may be reduced.

FIG. 6 indicates another example of a color combination in which the two stages of the color combination of FIG. 5 are replaced by multiple stages. As a result, the color patterns may be further reduced.

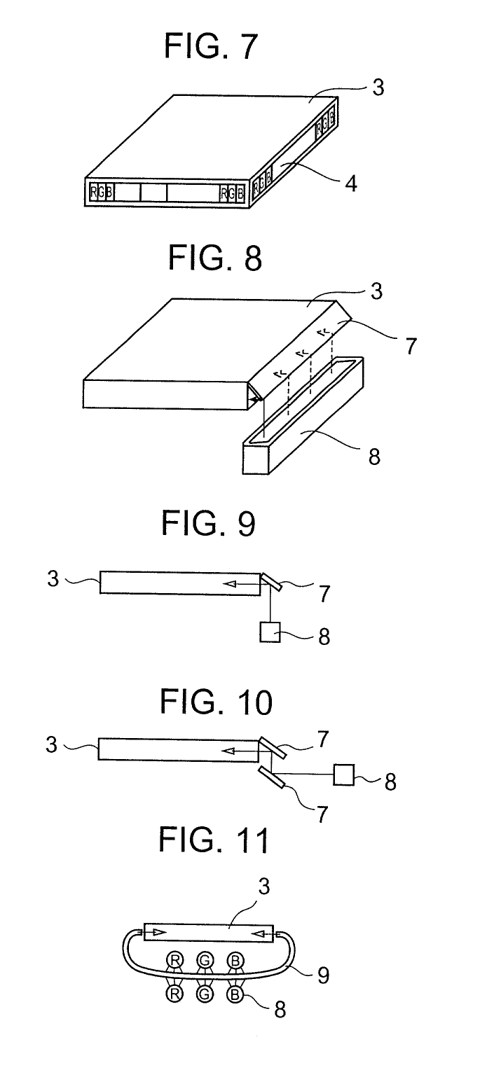

An embodiment indicated in FIG. 7 is so arranged that the light emitting elements 4 made of the three RGB colors are arranged in a serial manner, and further are arranged on the entire side surfaces of the light conducting plate 3. As a result, the light conducting plate 3 can be made slim, and the high brightness of the flat plate display apparatus can be realized.

An embodiment shown in FIG. 8 is such an example that a reflection plate 7 is provided on a side surface of a light conducting plate 3, and this reflection plate 7 acquires light projected from a separately provided light source 8 so as to use this acquired light as lighting of a flat plane display apparatus. Although much higher brightness is required as compared with the light emitting element 4 provided on the outer peripheral portion of the light conducting plate 3 is required, this embodiment is suitable for such a constructive restriction that light emitting elements cannot be mounted due to the shape or the size thereof. Alternatively, when a large light source is employed, light projected from the light source may be collected to the reflection plate 7 by employing a lens (not shown).

FIG. 9 is a sectional view of the flat plane display apparatus shown in FIG. 8. FIG. 10 is such an example that while plural sets of reflection plates 7 are provided, a direction of a light source is made different from a light emitting direction. It should be noted that the positions and the total quantities of the reflection plates 7 may be properly set in accordance with the light sources and the constructions.

An embodiment indicated in FIG. 11 corresponds to such an example that while an optical fiber 9 is employed, light made of three RGB colors is collected to be conducted to a light conducting plate 3. A light source 8 is arranged on a side surface of the optical fiber in a proper manner, so that light can be collected. Therefore, light with high brightness can be obtained irrespective of the shape of the light source, while no lens is employed. Although the optical fiber is arranged in vicinity of both edge planes of the light conducting plate 3, in order to make a slim flat plane display apparatus, this optical fiber may be used only on a single edge plane of the light conducting plate 3.

While the present invention is embodied in accordance with the above-explained embodiment modes, the present invention can achieve the below-mentioned effects.

While the lighting apparatus is arranged in the flat plane display apparatus, the color temperature of this lighting apparatus is adjusted. As a result, the color temperature correction of the flat plane display apparatus can be carried out without reducing the total color representation number of the liquid crystal flat plane display apparatus.

Then, when the lightening apparatus is constituted by light sources made of three RGB colors, the light emission strengths of the respective three RGB colors are adjusted, so that the display color temperature of the flat plane display apparatus can be readily corrected.

Furthermore, when the lighting apparatus is constituted by light emitting elements of three RGB colors, the color temperature correction of the flat plane display apparatus can be easily carried out. In addition, the lighting apparatus can be made with such superior features as high brightness (luminance), compactness, low power consumption, long lifetime, anti-shock characteristic.

Also, while the flat plane display module is arranged by white liquid crystal and the light emitting elements of three RGB colors, since the color temperature control is carried out, it is possible to obtain a desirable color temperature liquid crystal screen.

Also, while the light conducting plate is provided with the lighting apparatus, since the light emitting elements made of three RGB colors are arranged on the side surface of the light conducting plate, the lighting apparatus can be made slim.

Furthermore, in the case that light emitting elements made of three RGB colors used as the lighting apparatus are arranged on the side surface of the light conducting plate, one set of the light emitting elements made of the three RGB colors is constituted by closely combining these light emitting elements in the serial manner, and plural sets of these light emitting elements are repeatedly arranged in the serial manner. Also, one set of the light emitting elements made of the three RGB colors is arranged by closely combining these light emitting elements at each of the vertexes of the triangle, and one set of these light emitting elements is arranged in such a manner that this one set is alternatively and repeatedly arranged in the triangular manner and the inverse-triangular manner. As a result, the three RGB colors are mixed with each other in the proper manner, so that such ideal white light having the small number of color patterns can be obtained from the light emitting surface of the light conducting plate.

Also, since the reflection plate is arranged on the side surface of the light conducting plate in order to conduct light emitted from the light source made of the three RGB colors to this reflection plate, the flat plate display apparatus may be adapted to various shapes of lighting apparatus, or various types of lighting apparatus.

Then, while the light sources made of the three RGB colors are employed as lighting in the flat plate display apparatus, when the color temperatures are properly adjusted by combining the three colored light emissions with each other, the display screen of the flat plate display apparatus can be set to the desirable temperature without reducing a total number of representable colors.

What is claimed is:

1. A display color temperature corrected lighting apparatus comprising:
a lighting apparatus which is added to either a front surface or a rear surface of a flat plane display apparatus;
wherein the lighting apparatus changes a color temperature,
a display temperare of the flat plane display apparatus is corrected by changing a color temperature of a lighting apparatus.

2. A flat plane display apparatus comprising:
a display temperature corrected lighting apparatus;
wherein the display temperature corrected lighting apparatus corrects a display color temperature of a flat plane display element by changing a color temperature of a lighting apparatus.

3. A flat plane display apparatus as claimed in claim 2, wherein the lighting apparatus corrects the color temperature by lighting made of three RGB colors.

4. A flat plane display apparatus as claimed in claim 2, wherein the lighting apparatus includes a light emitting element made of three RGB colors.

5. A flat plane display apparatus as claimed in claim 4, wherein the lighting apparatus color-temperature-corrects white liquid crystal by using a light emitting element made of three RGB colors.

6. A flat plane display apparatus as claimed in claim 4, wherein the light emitting element is arranged on a side surface of a light conducting plate.

7. A flat plane display apparatus as claimed in claim 6, wherein in the lighting apparatus, one set of light emitting elements made of three RGB colors is constituted by closely combining the light emitting elements in a serial manner on the side surface of the light conducting plate, and plural sets of light emitting elements are repeatedly arranged in a serial manner.

8. A flat plane display apparatus as claimed in claim 6, wherein in the lighting apparatus, one set of light emitting elements made of three RGB colors is constituted by closely combining the light emitting elements on the side surface of the light conducting plate at each of vertexes of a triangle, and the one set of light emitting elements is arranged in such a manner that the one set is alternately and repeatedly arranged in the triangular manner and the inverse-triangular manner.

9. A flat plane display apparatus as claimed in claim 3, wherein the lighting apparatus includes a reflection plate on a side surface of the light conducting plate, and conducts light made of three RGB colors emitted outside the lighting apparatus to the light conducting plate.
